(19) United States
(12) Patent Application Publication
(10) Pub. No.: US 2025/0086527 A1
(43) Pub. Date: Mar. 13, 2025

(54) OPERATIONAL SIMULATIONS OF FAULT-INDUCED SCHEDULE DELAYS USING PROBABILISTIC MODELS

(71) Applicant: The Boeing Company, Arlington, VA (US)

(72) Inventor: Bronwyn A. Jackson, Seattle, WA (US)

(21) Appl. No.: 18/464,108

(22) Filed: Sep. 8, 2023

(51) Int. Cl. G06Q 10/04

(52) U.S. Cl. CPC G06Q 10/04

(57) ABSTRACT

Systems and methods for simulating operational impact of unplanned maintenance using probabilistic models are provided. One aspect provides a computing system comprising one or more processing devices configured to provide a plurality of operational models with operational data comprising a route model, a preparation model, a fault model, and an unplanned maintenance delay model. The one or more processing devices is further configured to, using the plurality of operational models, execute an operational simulation that generates interactions between a route simulation and an unplanned maintenance simulation for a plurality of routes in a route schedule, wherein simulating each route of the plurality of routes comprises simulating whether a fault occurs using the fault model, if a simulated fault occurs, determining fault type for the simulated fault, calculating unplanned maintenance time, and calculating delay.

### FIELD

This invention is directed to the field of route delay simulations and, more specifically, route delay simulations using probabilistic models.

### BACKGROUND

Route scheduling is a logistics exercise in which arrival times and departure times are scheduled for a plurality of vehicles for a plurality of routes. The scheduling itself is a simple organizational task. In an ideal scenario, routes are completed with the arrival/departure times occurring as scheduled. However, in real scenarios, various factors such as vehicular failures and corresponding unplanned maintenance tasks can cause delays, resulting in unpredictable vehicle availability and route operation. Various methods for examining the operational impact of unplanned maintenance have been contemplated. However, such methods typically assume that fault occurrence is uniformly distributed over time and are capable of generating only conclusory information that provides little assistance in determining the operational impact of a variety of faults across a fleet of vehicles over an extended period.

### SUMMARY

Systems and methods for simulating operational impact of unplanned maintenance using probabilistic models are provided. One aspect provides a computing system comprising one or more processing devices configured to provide a plurality of operational models with operational data comprising a route model comprising information describing a route schedule for the plurality of vehicles, a preparation model comprising information describing tasks to prepare a vehicle for departure, a fault model comprising information describing a plurality of fault types, occurrence probabilities associated with the plurality of fault types, and repair resources associated with the plurality of fault types, and an unplanned maintenance delay model for computing delay information. The one or more processing devices is further configured to, using the plurality of operational models, execute an operational simulation that generates interactions between a route simulation and an unplanned maintenance simulation for a plurality of routes in the route schedule, each route associated with a vehicle of the plurality of vehicles, wherein simulating each route of the plurality of routes comprises simulating whether a fault occurs using the fault model, if a simulated fault occurs, determining fault type for the simulated fault using the occurrence probabilities of the fault model, calculating unplanned maintenance time using the unplanned maintenance delay model and the repair resources associated with the simulated fault, and calculating delay using the preparation model and the unplanned maintenance time. The one or more processing devices is further configured to output the delays.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example computing system for performing an operational simulation for a plurality of routes.

FIG. 2 shows a diagram of a process flow for simulating unplanned maintenance events using an example unplanned maintenance delay model.

FIG. 3 shows a diagram of a process flow for simulating unplanned maintenance events using an example unplanned maintenance delay model and an example parts model.

FIG. 4 shows a diagram of an example process of calculating delay due to unplanned maintenance events.

FIG. 5 shows a diagram of an example aircraft preparation model for operational simulation of a fleet of aircraft.

FIG. 6 shows a flow diagram of an example method for performing an operational simulation for a plurality of routes.

FIG. 7 shows an example computing system in which the computing system of FIG. 1 may be instantiated.

### DETAILED DESCRIPTION

Route scheduling for a fleet of vehicles is a complex logistics operation involving a large number of components. For example, scheduling routes for aircraft operation can involve commercial service scheduling, planned maintenance scheduling, location of maintenance resources, maintenance facility capabilities, etc. Additionally, unplanned events can cause delays that, in some cases, result in cascading effects throughout a number of routes—e.g., a delay in arrival time of a first route can result in a delay in departure time of the subsequent route, which can further cause a delay in the arrival time of the subsequent route. One source of such delays includes unplanned maintenance to be performed on vehicles due to the occurrence of faults. A fault refers to any indication describing potential issues with a vehicle. One example includes a fault occurring due to failure of a part of the vehicle.

The effects of faults and their operational impact on route scheduling can vary, ranging from no effect to route delays/cancellations. Examining the effects of different faults can provide valuable insight into where and how to apply mitigation efforts. For example, if a certain fault is determined to cause excessive route delays, efforts in preventing or reducing the occurrence of said fault can be an efficient use of resources. Previous methods of examining the operational impact of faults evaluate these issues on a general level, providing conclusory information that gives little insight in determining the operational impact of a specific fault and, as such, provides little information for directing mitigation efforts. For example, typical methods for simulating faults and route operations are generally performed using separate, isolated models. In such methods, information is not shared or utilized among the models, which prevents analysts from uncovering various interactions and cascading effects that commonly occur in fleet operations. Another disadvantage of previous fault assessment models is that they are generally not time-based. They may predict general information such as the average number of a set of parts required for a year of fleet operations. Such predictions are performed on the assumption that the occurrence of faults is uniformly distributed across time. However, in real scenarios, it is not uncommon to have clusters of similar or related faults.

Furthermore, such methods often inaccurately estimate the availability of vehicles in a fleet. For example, previous methods for modeling flight route simulations can overestimate availability by not taking into account route cancellations (e.g., due to extensive delays caused by faults) and the availability of gates (e.g., if the aircraft is late or early). These implementations can also underestimate availability if parallel operations are not correctly modeled (e.g., an aircraft with a non-operational period can have maintenance performed to cure faults within said period without affecting the route schedule).

In view of the issues described above, systems and methods for performing time-based operational simulations for determining operational impact of unplanned maintenance events using probabilistic models are provided. As described in more detail below, and in one potential advantage of the present disclosure, time-based operational simulations of the present disclosure generate interactions between or among two or more different simulations, such as a route simulation and an unplanned maintenance simulation. Time-based operational simulations for determining operational impact of unplanned maintenance events can be performed using any suitable probabilistic modeling techniques (e.g., Monte Carlo models and simulations). Such operational simulations can be performed using a plurality of operational models and operational data. In some implementations, the plurality of operational models includes a route model, a preparation model, a fault model, and an unplanned maintenance delay model. Use of additional, or alternative, operational models can provide operational impact assessment with higher fidelity. For example, operational models can be implemented in an event based operational simulation that characterizes responses to delays in arrival and departure times with delay, cancellation, ferry, swap and spare models.

Operational simulations using probabilistic models take into account the operating rhythm of a fleet of vehicles over a route schedule, allowing for assessment of the operational impact of certain faults and the unplanned maintenance for curing such faults. Additionally, such simulations can be performed to enable long term analysis—e.g., over timeframes of months-to-years. Operational simulations described herein can be performed to provide various assessments of operational impact due to unplanned maintenance events. For example, operational simulations can be performed to estimate the number of resources needed to operate a plurality of vehicles over a given route schedule. Assessment of the operational simulations can provide information on more efficient route schedules given a predetermined maintenance budget. More efficient route schedules can include routing vehicles likely in need of maintenance to transit locations with more appropriate maintenance resources. In another example, operational simulations can be performed to predict the risks and effects of when a new fault is uncovered and/or when a fault occurs more frequently than anticipated.

Operational simulations can be performed to include unplanned maintenance simulations that model the occurrences of faults to determine which faults are commonly linked to route delays/cancellations. For example, performing an unplanned maintenance simulation within an operational simulation can determine when a fault does or does not affect a route schedule. In practice, these assessments can be used to analyze the operational impact of the expected reliability and/or the impact of changes to part reliability (e.g., a new part that breaks less frequently can lead to fewer delays, a part that breaks more frequently than previously thought can lead to increases in maintenance time and costs, etc.). Another aspect that can be analyzed includes the effects of parts having different maintenance costs (e.g., a new part that is more reliable may have a high maintenance cost that adversely affects the route schedule in spite of its higher reliability).

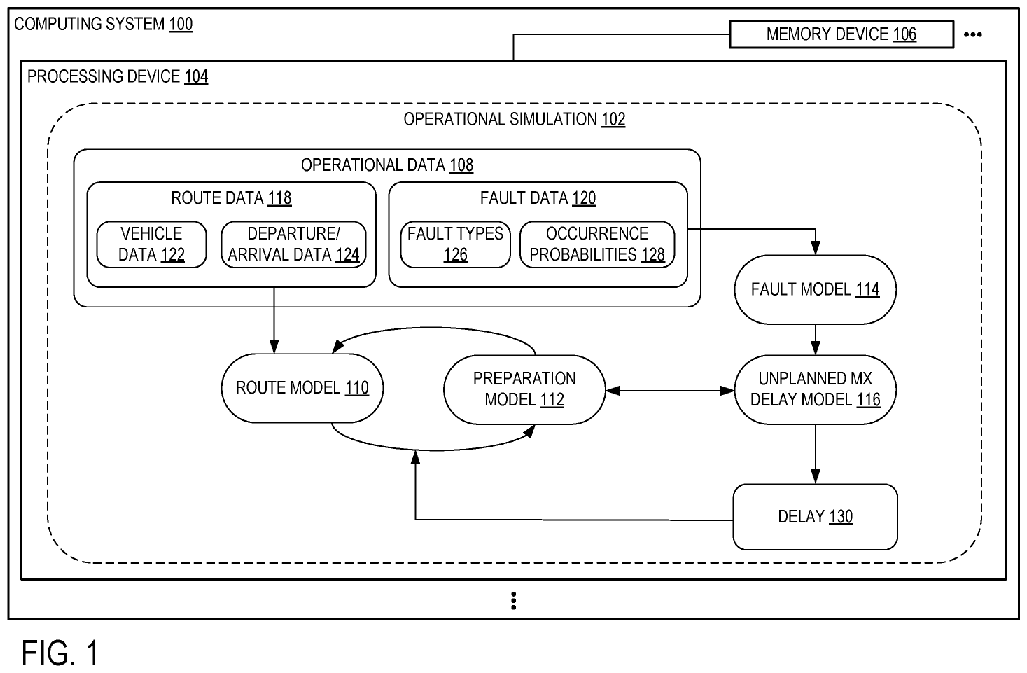

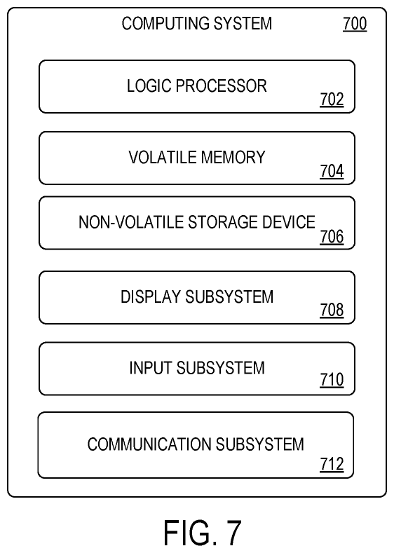

Turning now to the drawings, systems and methods for performing time-based operational simulations for determining operational impact of unplanned maintenance events for a plurality of vehicles using probabilistic models are described. FIG. 1 shows an example computing system 100 for performing an operational simulation 102 for a plurality of routes associated with a plurality of vehicles. As shown, the computing system 100 includes a processing device 104 (e.g., a logic processor such as a central processing unit (CPU)) and a memory device 106 (e.g., volatile and non-volatile memory) operatively coupled to each other. Other components such as input/output subsystems (not shown) can also be included. The memory device 106 stores instructions that, upon execution by the processing device 104, cause the processing device 104 to perform the operational simulation 102. Additional details regarding processing device 104, memory device 106, and other components, subsystems, and algorithms of computing system 100 are described further below with reference to FIG. 7.

The operational simulation 102 can be performed to simulate the operational impact of unplanned maintenance events for various applications. For example, the operational simulation 102 can be performed to simulate passenger transit routes for a fleet of aircraft, buses, or any other vehicles. The operational simulation 102 can be performed using a plurality of operational models and operational data 108. In the depicted example, the plurality of operational models includes a route model 110, a preparation model 112, a fault model 114, and an unplanned maintenance delay model 116. The operational simulation can include additional operational models, which can enhance fidelity of the operational impact assessment. Examples of other operational models include models of planned maintenance requirements, models of maintenance resources, models of mitigation products (e.g., aircraft health management) and their effects, parts availability models, cancellation/ferry/swap/spare models, etc. Different applications can advantageously implement certain models. For example, aircraft route simulations can include the use of taxi/tow models.

The operational data 108 includes data used by the plurality of operational models to perform the operational simulation 102. In the depicted example, the operational data 108 includes route data 118 and fault data 120. The operational data 108 can also include other types of data. For example, parts data can be used in conjunction with a parts model to increase fidelity of the operational simulation 102. The route data 118 includes information describing a route schedule that includes a plurality of routes on which the operational simulation can be performed. The route schedule can be defined using vehicle data 122, which describes a fleet of vehicles, and departure/arrival data 124, which describes departure and arrival times of transit locations associated with the fleet of vehicles described in the vehicle data 122. The fault data 120 includes information describing a set of fault types 126 and occurrence probabilities 128 of the fault types 126. As can readily be appreciated, the operational data 108 can be implemented using other organizational schemes and/or formats.

The route model 110 can be implemented with the route data 118 to simulate operation of the route schedule described in the route data 118. The route schedule includes a plurality of routes, each associated with a vehicle of the fleet of vehicles. A route can be defined in various ways. In some implementations, a route includes information describing a departure time from a first transit location, an arrival time at a second transit location, and an identification of a vehicle operating on the route. A route can also include other information. For example, in an operational simulation for a fleet of aircraft, a route can include information describing the flight path from a first airport to a second airport (including departure and arrival times), flight phases, flight altitudes, taxi/tow times, etc.

The preparation model 112 describes and simulates tasks to prepare a vehicle for departure and to be performed within a preparation time period—i.e., the time period between the arrival time of a vehicle at a transit location and the departure time of the vehicle for its subsequent route. For example, in an aircraft route simulation, the preparation time period is the ground time of an aircraft between routes (i.e., the time period between landing and take-off for the subsequent route). In further examples, the preparation model 112 for an aircraft route simulation includes taxi/tow models. Example tasks to be performed within the preparation time period include the arrival of the vehicle, the inspection of the vehicle (e.g., for faults), and the performance of maintenance (e.g., planned and/or unplanned maintenance), if any, on the vehicle. Other example tasks can include cleaning and refueling the vehicle. As can readily be appreciated, the type of tasks simulated can depend on the application. In an aircraft route simulation, the preparation model can be described as a ground model that includes tasks such as passenger deplaning/boarding, the unloading/loading of bags, aircraft taxiing, etc.

The preparation model 112 can model and simulate tasks using discrete and/or probabilistic methods. For example, the task time of a given task within the preparation model can be simulated to take N minutes. Alternatively, the task time can be simulated using a probability distribution (e.g., a normal distribution). Parameters of the probability distribution (e.g., mean, standard deviation, etc.) can be predetermined based on real-world data. The parameters can be updated to reflect any changes in the real-world data. In some implementations, the task time is dependent on various conditions (e.g., type of vehicle, current transit location, available resources, etc.). For example, the preparation model can simulate the task time of a given task differently for different vehicles (e.g., different vehicle models may have different refueling times). As another example, the arrival time can be simulated to have a different probability distribution for different transit locations (e.g., certain transit locations may have more late arrivals statistically due to weather, traffic congestion, etc.). The task time can also be based on a conditional dependency. In some implementations, simulation of a task time for a given task can depend on the occurrence/non-occurrence of an event. For example, a vehicle arriving late to a transit location (e.g., due to required unplanned maintenance) can affect the task time of the refueling step (e.g., additional wait time on resources needed for the refueling step). The various dependencies described above can be implemented in both discrete and probabilistic simulations.

The fault model 114 can be implemented with the fault data 120 to model faults that can occur during routes of the route schedule. Information describing the faults can be organized in various ways. In some implementations, the fault model 114 describes a set of fault types (e.g., fault types 126), each associated with an occurrence probability (e.g., occurrence probabilities 128). Additionally, each fault type can be associated with a set of repair resources. Repair resources can include time resource, labor resource, part resource, and/or any other resource for performing maintenance to cure the associated fault type. For example, repair resources associated with a fault type can include the time it takes to perform maintenance to repair the fault type (which can include research time for identifying the fault type and/or determining maintenance tasks to be performed) (a time resource), the expertise required to perform maintenance to repair the fault (which can include human expertise or maintenance facilities' capabilities) (a labor resource), and/or identification of part(s) needed to perform maintenance to repair the fault (which can include parts model number, alternative parts, etc.) (a part resource).

The unplanned maintenance delay model 116 uses the fault model 114 to simulate occurrences (or non-occurrence) of faults in the route schedule to calculate delay information 130. Delay information 130 can be calculated in various ways. In some implementations, delay information 130 is calculated based on unplanned maintenance time (for repairing the simulated faults) and information from the preparation model 112. Unplanned maintenance time can be determined based on the simulated faults and information provided by the fault model 114 and the fault data 120. For example, information describing the repair resources associated with the simulated fault and its fault type can be used to simulate an unplanned maintenance time for repairing the simulated fault. The unplanned maintenance time for a simulated fault can be simulated using discrete or probabilistic methods and can be based on various factors, such as the repair resources associated with the simulated fault type and the maintenance capabilities of the current transit location. In some implementations, the repair resources include probabilities of time resources. For example, the repair resources can include a probability distribution for each fault type describing the likelihood of different unplanned maintenance times for the given fault type. The unplanned maintenance delay model 116 can utilize such information to simulate an unplanned maintenance time for repairing a simulated fault (e.g., a probabilistic drawing can be performed using the probability distribution associated with the simulated fault type).

Information from the preparation model 112 provides context that can determine the impact, if any, that the unplanned maintenance time has on the route schedule. For example, the preparation model 112 can provide schedule slack information, which describe the slack time, if any, between routes for a given vehicle. Slack time is a period of time within the preparation time period that provides a buffer in which tasks can be performed without affecting the departure time of the subsequent route. For example, slack time can include scheduled time in the route schedule intended for providing a buffer period for any delayed route to “catch up.” Slack time can also include any extra time provided due to early completion of preparation tasks—e.g., early simulated arrival times. As such, in some cases, the route schedule may be unaffected by any unplanned maintenance that is to be performed. As another example, the arrival time simulated in the preparation model 112 can affect whether the unplanned maintenance time causes a delay for the next route in the route schedule. An arrival time earlier than expected may provide a longer buffer period in which unplanned maintenance can be performed without causing a delay.

The delay information 130 can be used for various purposes. For example, the delay information 130 can be used to update the route schedule described in the route model. Delays in one route may cause a delay in a subsequent route by the same vehicle. For example, a fault occurring in a vehicle can require unplanned maintenance to repair the fault. The unplanned maintenance can cause a delay that results in the vehicle not being able to depart at its scheduled departure time for its subsequent route. In such cases, the route schedule can be updated to reflect the delay in the departure time, which can cascade and affect subsequent routes. As described above, slack time can provide a buffer period in which delayed routes can “catch up.” As such, the cascading effects do not necessarily propagate throughout the entire route schedule. By simulating these events using probabilistic models, operational simulations performed by the example system 100 of FIG. 1 enable assessment of the operational impact of unplanned maintenance events that takes into account various dynamic components in the operation of a route schedule.

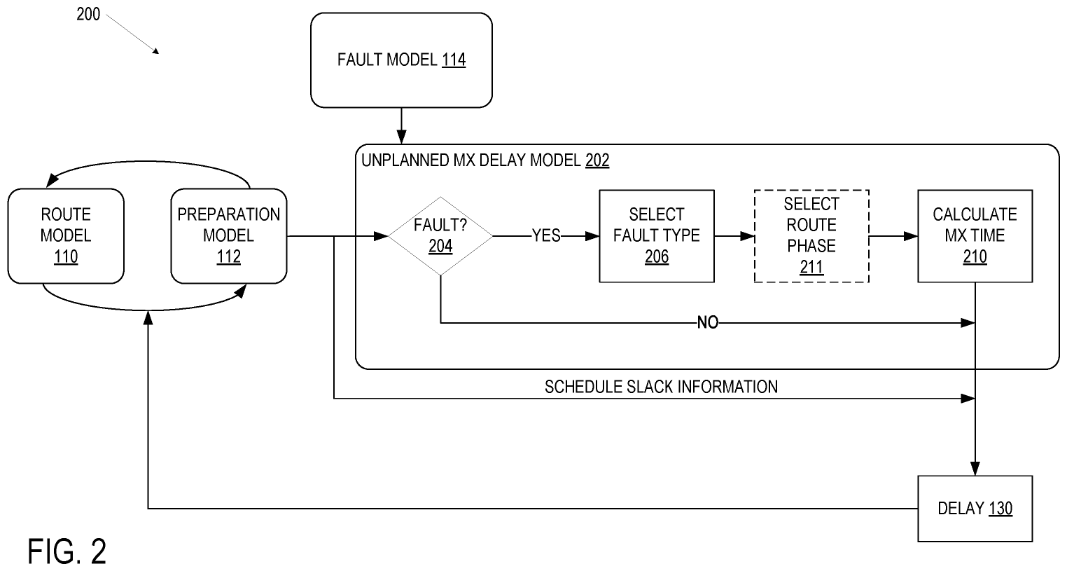

FIG. 2 shows a diagram 200 of a process flow for simulating unplanned maintenance events using an example unplanned maintenance delay model 202. For each route of the route schedule, a simulation can be performed to determine which fault(s), if any, occur in the vehicle for the given route. The process flow for simulating unplanned maintenance events for a route using the unplanned maintenance delay model 202 includes an input from the preparation model 112. Input received from the preparation model 112 can include arrival information describing a simulated arrival time of a vehicle at a transit location for the previous route. The unplanned maintenance delay model 202 then simulates the occurrences of faults for the arrived vehicle using the fault model 114.

The simulation of faults includes simulating whether a fault occurs 204 in the route to be simulated. In some implementations, a probabilistic drawing is performed to determine whether a fault occurs. The probability can be provided by operational data and can be predetermined based on real-world data describing how often faults occur across a plurality of vehicles for a plurality of routes. The unplanned maintenance delay model 202 can be configured with the capability of simulating more than one fault for the route to be simulated, such as is the case in real operations. Simulating multiple faults can be performed in various ways. In some implementations, the probabilistic drawing to determine whether a fault occurs includes multiple outcomes, representing zero fault to a predetermined maximum number of faults. In other implementations, the probabilistic drawing is a binary drawing that is repeatedly performed until “no fault” is drawn.

For each fault simulated, the unplanned maintenance delay model 202 simulates a fault type 206. Various methods can be used to simulate and determine the fault type. In some implementations, the unplanned maintenance delay model 202 uses the fault model 114 to perform a probabilistic drawing to determine the fault type. Probabilities for each fault type can be provided through operational data containing fault data that describes occurrence probabilities for each fault type. In some implementations, there exists covariance between faults (e.g., the occurrence of one fault increases or decreases the probability of the occurrence of a second fault).

For each fault simulated, the unplanned maintenance delay model 202 calculates an unplanned maintenance time 210. Unplanned maintenance time for a fault can be calculated using various methods, which can depend on the implementation of the unplanned maintenance delay model 202. For example, the unplanned maintenance delay model 202 can optionally include simulating to simulate the route phase in which a simulated fault occurs and/or is detected 211. The route phase in which the fault occurs can affect the calculation of the unplanned maintenance time 210. In some implementations, the unplanned maintenance delay model 202 uses information from the fault model 114 to determine the unplanned maintenance time for a given fault. For example, fault data provided by the fault model 114 can describe repair resources for each fault type, which can be used to determine, at least in part, the unplanned maintenance time of the associated fault type. Repair resources can include time resource, labor resource, part resource, and/or any other resource for performing maintenance to cure the associated fault type. In some implementations, unplanned maintenance time includes research time for identifying the fault and/or determining maintenance tasks to be performed. As can readily be appreciated, each component of the unplanned maintenance time can be simulated using discrete and/or probabilistic drawings. Other factors can also be used to determine or adjust the unplanned maintenance time. For example, the current transit location may have different maintenance capabilities that affect the unplanned maintenance time.

The calculated unplanned maintenance time can then be used to calculate delay 130, if any, in the route. Additional information can be used to calculate the delay 130. In the depicted example, information from the preparation model 112 describing schedule slack is used in combination with the calculated unplanned maintenance time to determine the delay 130. Schedule slack information, which can be affected by the arrival information, can affect the delay 130. If no fault is simulated, the delay 130 can be calculated accordingly using just information from the preparation model 112 (e.g., a delay in departure time may still occur if the vehicle arrives late from the previous route in spite of no fault being simulated).

FIG. 2 shows operation of an example unplanned maintenance delay model 202. Other configurations can also be utilized. For example, the unplanned maintenance delay model 202 does need not to simulate a route phase. Additional steps or models can be used to increase fidelity of the simulation. Examples of other operational models include models of planned maintenance requirements, models of maintenance resources, models of mitigation products and their effects, parts availability models, cancellation/ferry/swap/spare models, etc.

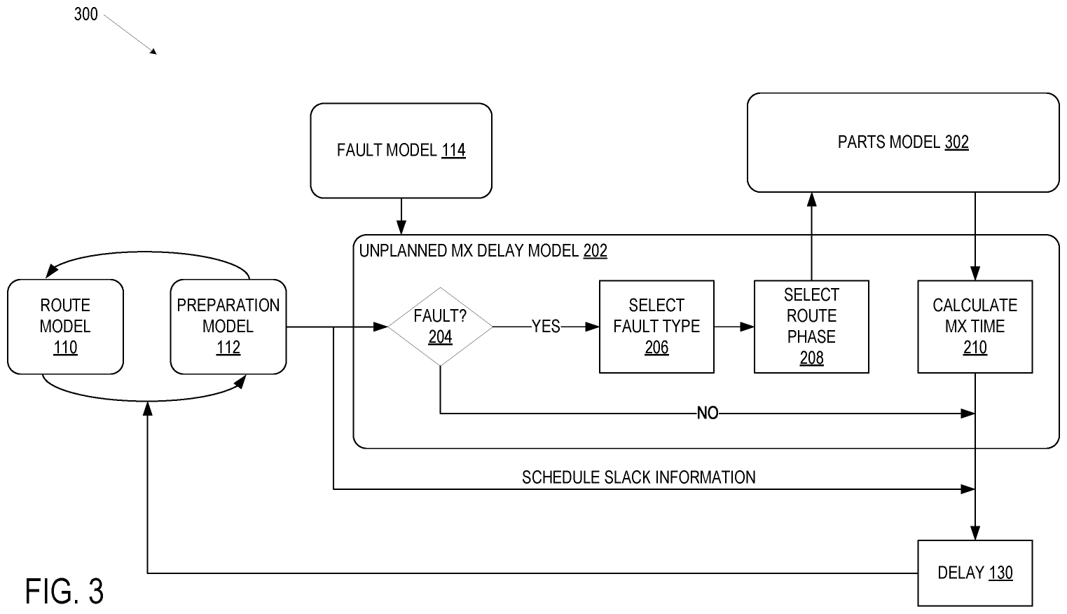

FIG. 3 shows a diagram 300 of a process flow for simulating unplanned maintenance events using an example unplanned maintenance delay model 202 and an example parts model 302. The process flow is similar to that of the diagram depicted in FIG. 2 but includes the use of the parts model 302 to augment the calculation of the unplanned maintenance time 210 performed using the unplanned maintenance delay model 202. After faults and fault types are simulated, the parts model 302 simulates the effects of parts availability and repair attempts using different parts in the calculation of unplanned maintenance time after the arrival of the vehicle in the current route being simulated.

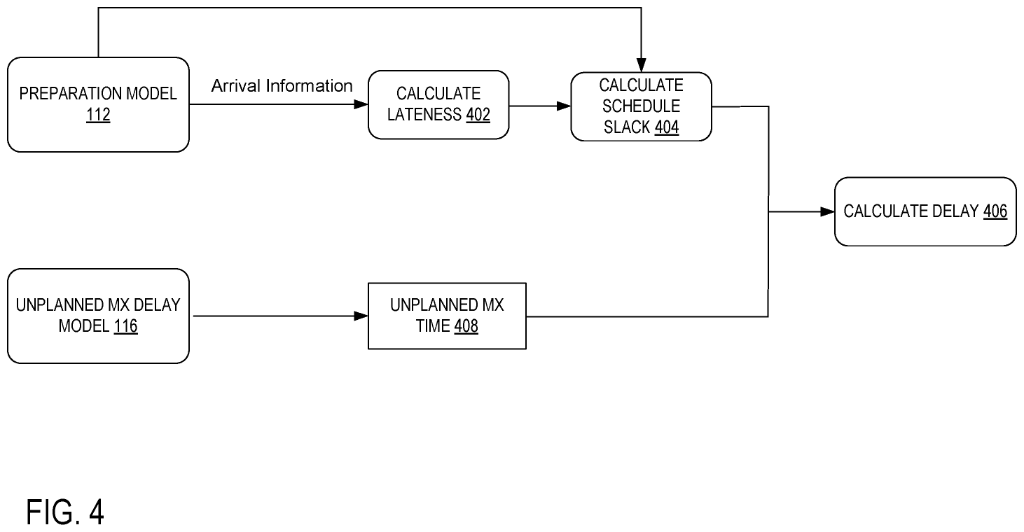

FIG. 4 shows a diagram of an example process of calculating delay due to unplanned maintenance events. The calculation of delays, such as those described herein with respect to FIGS. 1-3, can be performed in various ways. FIG. 4 describes a process flow for one such method. In the depicted example, the process includes calculating lateness 402 using arrival information from the preparation model 112. Lateness can be calculated in various ways. For example, lateness can be calculated by comparing the scheduled arrival time and the actual arrival time (which can differ due to various factors such as unplanned maintenance delays, weather, traffic, etc.) of the given route.

Lateness information can be used to further calculate and determine schedule slack information 404. Routes can be scheduled to provide slack time in between routes to accommodate for various delays in operation, allowing a route schedule operating with delayed routes to “catch-up” using the slack time. However, late arrivals can reduce the amount of slack time for a given preparation phase. In some implementations, slack time is calculated by comparing the scheduled time for the preparation tasks (which can include more time than expected to perform such tasks, providing a buffer) and the actual time the vehicle spent performing preparation tasks.

The schedule slack information can be used to calculate delay 406 in the route (e.g., delay in departure time). In addition to schedule slack information, unplanned maintenance time 408 can also affect the delay calculation. For example, if a fault is simulated, the unplanned maintenance time 408 calculated by the unplanned maintenance delay model 116 is used in combination with the calculated schedule slack information to calculate the delay 406. FIG. 4 describes one process for calculating delays. Other methodologies can be implemented to achieve similar calculations. For example, computations of the schedule slack information 404 accounts for the unplanned maintenance time 408. Furthermore, different applications may take different approaches.

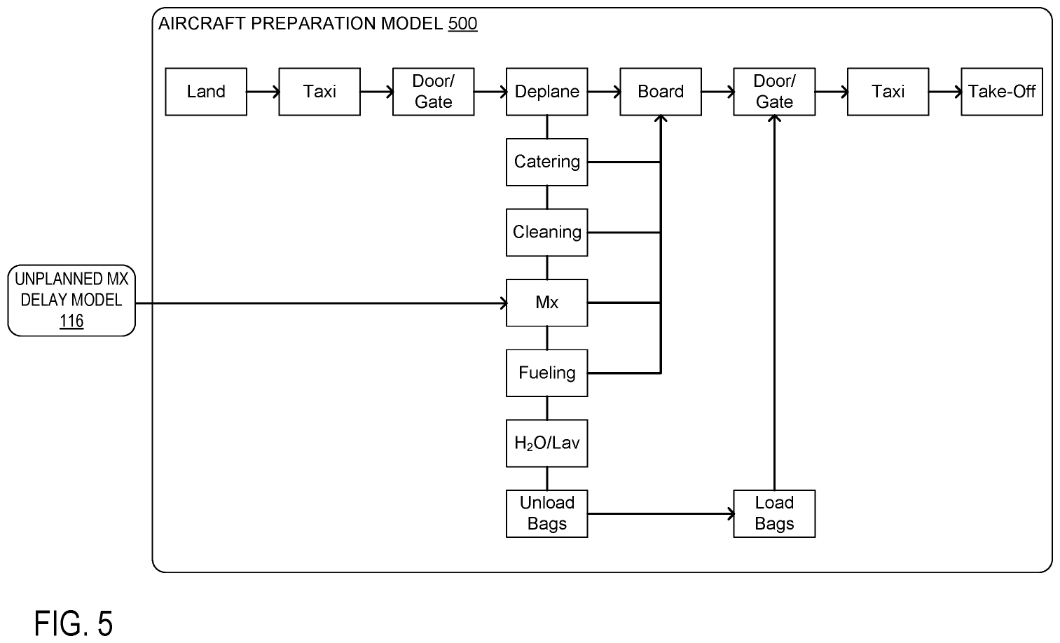

FIG. 5 shows a diagram of an example aircraft preparation model 500 for operational simulation of a fleet of aircraft. An aircraft preparation model can also be referred to as a ground model. The example aircraft preparation model 500 describes various tasks to be performed before departure (take-off). The example aircraft preparation model 500 includes tasks that have to be performed sequentially and tasks that can be performed simultaneously. In the depicted example, the tasks that have to be performed sequentially include “land”, “taxi”, “door/gate”, “deplane”, “board”, “door/gate”, “taxi”, and “take-off”. The “load bags” task can be performed after “unload bags” task and before the second “door/gate” task that occurs before taxiing and take-off. In the depicted example, the tasks that can be performed simultaneously include “deplane”, “catering”, “cleaning”, “maintenance”, “fueling”, “H₂O/lav”, and “unload bags”. The tasks “deplane”, “catering”, “cleaning”, “maintenance”, and “fueling” are to be performed before the “board” task. As can readily be appreciated, aircraft preparation models, and preparation models in general, can be configured to simulate any type of tasks associated with the preparation phase and can include any type of temporal dependencies.

Simulation of the preparation tasks includes simulating the time it takes to perform said tasks. Tasks can be simulated to take a discrete and/or probabilistic amount of time. For example, “door/gate” and “taxi” tasks are often reliable and can be modeled as taking a discrete amount of time. Task times simulated using probabilistic methods can use any type of probability function. For example, a normal distribution can be utilized, and a probabilistic drawing is performed to determine the task time for a given task. Parameters of the probability functions can be predetermined (e.g., based on real-world data) and can be different for each task. Simulation of certain tasks can depend on information from other models. For example, the “land” task can depend on departure information from a previous route. The “maintenance” task can include unplanned maintenance simulated using an unplanned maintenance delay model 116.

By discretizing the preparation phase into multiple tasks and simulating the time it takes to perform each task individually and in accordance with any temporal dependency, the preparation model enables an operational simulation that accurately models the effect of unplanned maintenance and the resulting fault-induced delays. Furthermore, changes in the system (e.g., introduction of a new part, discovery of a new fault, etc.) can be modeled, and its effects can be assessed accurately. Additional models can be implemented to further improve the fidelity of the simulation. For example, a maintenance resource model can be implemented in the simulation to improve fidelity by providing information and context regarding which tasks can be performed at which transit location due to resource availability.

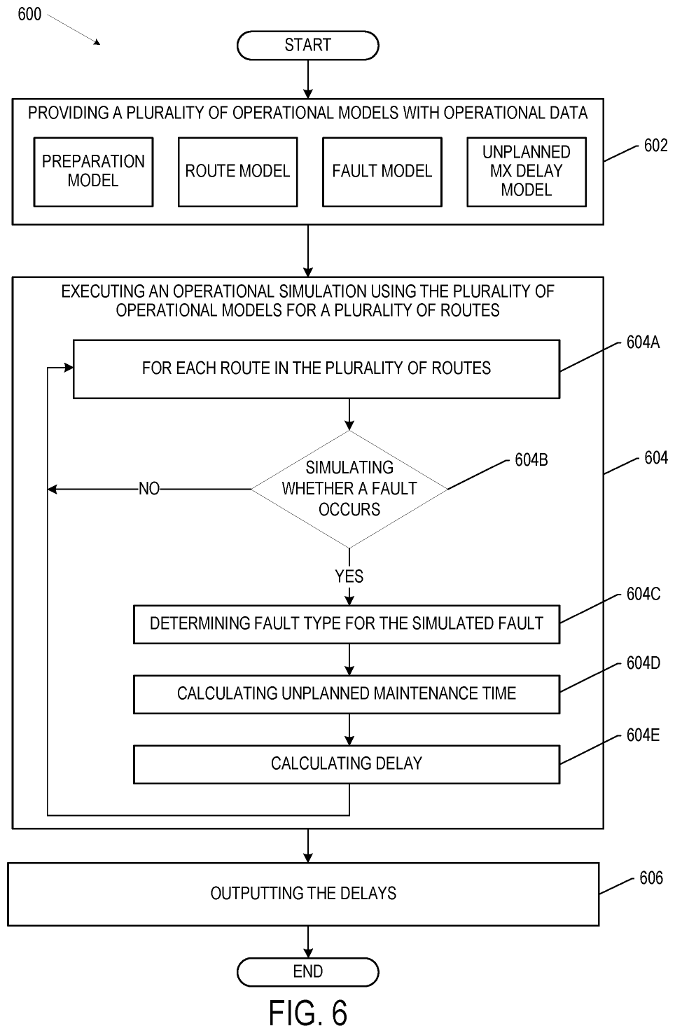

FIG. 6 shows a flow diagram of an example method 600 for simulating operational impact of unplanned maintenance for a plurality of vehicles. The following description of method 600 is provided with reference to the computing system 100 and related components described herein and shown in FIGS. 1-5. In other examples, the method 600 can be performed with other computing devices and in other contexts using other suitable devices and components. The method 600 includes, at step 602, providing a plurality of operational models with operational data. The plurality of operational models includes a preparation model, a route model, a fault model, and an unplanned maintenance delay model. In some implementations, the operational simulation includes one or more additional operational models.

The operational data includes data used by the plurality of operational models to perform the operational simulation. In some implementations, the operational data includes route data and fault data. The operational data can include additional data, which can depend on the models used in the operational simulation. The route data includes information describing a route schedule that includes a plurality of routes on which the operational simulation can be performed. The route data further describes a plurality of vehicles operating on the route schedule. The fault data includes information describing a set of fault types and occurrence probabilities of the fault types. In some implementations, the occurrence probabilities described in the fault data include probabilities of each fault occurring for different phases of a route. The fault data can also include information describing repair resources for each fault type. Repair resources can include time resource, part resource, and labor resource, and/or any other resources for curing the associated fault. In some implementations, the repair resources include probabilities of time resources.

The method 600 includes, at step 604, executing the operational simulation using the plurality of operational models for a plurality of routes. For each route in the plurality of routes 604A, the method 600 includes simulating whether a fault occurs 604B. In some implementations, a probabilistic drawing is performed to determine whether a fault occurs in the given route. Simulation of faults can be repeated until a “no fault” occurs, allowing for multiple faults to occur in the same route. In some implementations, the probabilistic drawing methodology to determine whether a fault occurs includes multiple outcomes, each outcome describing the number of faults simulated.

For each fault simulated, the method 600 includes determining fault type for the simulated fault 604C. Various methods can be used to simulate and determine the fault type. In some implementations, occurrence probabilities described in the fault data are used to perform a probabilistic drawing to determine the fault type. In some implementations, there exists covariance between faults (e.g., a simulated occurrence of a first fault of the plurality of faults affects an occurrence probability associated with a second fault of the plurality of faults).

For each fault simulated, the method 600 optionally includes determining a phase in the respective route in which the simulated fault occurs. Depending on the phase in which the simulated fault occurs (or is detected), unplanned maintenance time can be affected. The inclusion of such a step can improve fidelity of the operational simulation.

For each fault simulated, the method 600 further includes calculating unplanned maintenance time 604D. Unplanned maintenance time for a fault can be calculated using various methods. In some implementations, the unplanned maintenance delay model uses information from the fault model to determine the unplanned maintenance time for a given fault. Such information can be provided by the fault data. For example, repair resources information can be used to determine unplanned maintenance time for a given fault. In some implementations, calculating the unplanned maintenance time includes using probabilities of time resources associated with the simulated fault (e.g., a probabilistic drawing can be performed using the probabilities of time resources associated with the simulated fault type). In some implementations, unplanned maintenance time includes a research time for identifying the fault and/or determining maintenance tasks to be performed. Each component of the unplanned maintenance time can be simulated using discrete and/or probabilistic drawings. Other factors, such as resource availability and transit location maintenance capabilities, can also be used to determine or adjust the unplanned maintenance time.

The method 600 further includes calculating delay 604E. The delay can be calculated using various methods. In some implementations, the delay is calculated based on the unplanned maintenance time and schedule slack information from the preparation model. Schedule slack information can be computed by the preparation model in various ways. For example, the schedule slack information can be computed based on scheduled preparation time and actual preparation time. If no fault is simulated, the delay can be calculated using information from the preparation model, such as arrival time information.

The method 600 includes, at step 606 outputting the delays. The calculated delays can be used for various purposes. For example, the method 600 can optionally include updating the route schedule based on the calculated delay. For example, a delay may result in a later departure time for the route, which can cascade and cause a later arrival time. As such, the route schedule can be updated accordingly.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 7 schematically shows a non-limiting embodiment of a computing system 700 that can enact one or more of the methods and processes described above. Computing system 700 is shown in simplified form. Computing system 700 may embody the computing system 100 described above and illustrated in FIG. 1. Components of computing system 700 may be included in one or more personal computers, server computers, tablet computers, network computing devices, mobile computing devices, mobile communication devices (e.g., smart phone), and/or other computing devices.

Computing system 700 includes a logic processor 702 volatile memory 704, and a non-volatile storage device 706. Computing system 700 may optionally include a display subsystem 708, input subsystem 710, communication subsystem 712, and/or other components not shown in FIG. 7.

Logic processor 702 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the logic processor 702 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Volatile memory 704 may include physical devices that include random access memory. Volatile memory 704 is typically utilized by logic processor 702 to temporarily store information during processing of software instructions. It will be appreciated that volatile memory 704 typically does not continue to store instructions when power is cut to the volatile memory 704.

Non-volatile storage device 706 includes one or more physical devices configured to hold instructions executable by the logic processors to implement the methods and processes described herein. When such methods and processes are implemented, the state of non-volatile storage device 706 may be transformed—e.g., to hold different data.

Non-volatile storage device 706 may include physical devices that are removable and/or built in. Non-volatile storage device 706 may include optical memory, semiconductor memory, and/or magnetic memory, or other mass storage device technology. Non-volatile storage device 706 may include nonvolatile, dynamic, static, read/write, read-only, sequential-access, location-addressable, file-addressable, and/or content-addressable devices. It will be appreciated that non-volatile storage device 706 is configured to hold instructions even when power is cut to the non-volatile storage device 706.

Aspects of logic processor 702, volatile memory 704, and non-volatile storage device 706 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 700 typically implemented in software by a processor to perform a particular function using portions of volatile memory, which function involves transformative processing that specially configures the processor to perform the function. Thus, a module, program, or engine may be instantiated via logic processor 702 executing instructions held by non-volatile storage device 706, using portions of volatile memory 704. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 708 may be used to present a visual representation of data held by non-volatile storage device 706. The visual representation may take the form of a graphical user interface (GUI). As the herein described methods and processes change the data held by the non-volatile storage device, and thus transform the state of the non-volatile storage device, the state of display subsystem 708 may likewise be transformed to visually represent changes in the underlying data. For example, computing system 100 can output calculated delays in various visual representations that are displayed by display subsystem 708, such as in a GUI. Display subsystem 708 may include one or more display devices utilizing virtually any type of technology. Such display devices may be combined with logic processor 702, volatile memory 704, and/or non-volatile storage device 706 in a shared enclosure, or such display devices may be peripheral display devices.

When included, input subsystem 710 may comprise or interface with one or more user-input devices such as a keyboard, mouse, touch screen, camera, or microphone.

When included, communication subsystem 712 may be configured to communicatively couple various computing devices described herein with each other, and with other devices. Communication subsystem 712 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 700 to send and/or receive messages to and/or from other devices via a network such as the Internet.

“And/or” as used herein means any or all of multiple stated possibilities. For example, the phrase “element A and/or element B” covers embodiments having element A alone, element B alone, or elements A and B taken together.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

Further, the disclosure comprises configurations according to the following clauses.

Clause 1. A computing system for simulating operational impact of unplanned maintenance for a plurality of vehicles, the computing system comprising: one or more processing devices configured to: provide a plurality of operational models with operational data, the plurality of operational models comprising: a route model comprising information describing a route schedule for the plurality of vehicles; a preparation model comprising information describing tasks to prepare a vehicle for departure; a fault model comprising information describing a plurality of fault types; and an unplanned maintenance delay model for computing delay information; using the plurality of operational models, execute an operational simulation that generates interactions between a route simulation and an unplanned maintenance simulation for a plurality of routes in the route schedule, each route associated with a vehicle of the plurality of vehicles, wherein simulating each route of the plurality of routes comprises: simulating whether a fault occurs using the fault model; if a simulated fault occurs, calculating unplanned maintenance time using the unplanned maintenance delay model and repair resources associated with the simulated fault; and calculating delay using the preparation model and the unplanned maintenance time; and output the delays.

Clause 2. The computing system of clause 1, wherein simulating each route of the plurality of routes further comprises updating the route schedule based on the calculated delay.

Clause 3. The computing system of clause 1 or clause 2, wherein the delay is calculated based on the unplanned maintenance time and schedule slack information from the preparation model.

Clause 4. The computing system of clause 3, wherein the schedule slack information is computed based on scheduled preparation time and actual preparation time.

Clause 5. The computing system of clauses 1 to 4, wherein simulating each route of the plurality of routes further comprises determining fault type for the simulated fault using occurrence probabilities associated with the plurality of fault types of the fault model, wherein the occurrence probabilities comprise probabilities of a fault type of the plurality of fault types occurring for different phases of a route.

Clause 6. The computing system of clause 5, wherein the simulation of each route of the plurality of routes further comprises determining a phase in the respective route in which the simulated fault occurs using the occurrence probabilities, and wherein the unplanned maintenance time of the simulated fault is calculated further using the determined phase of the simulated fault.

Clause 7. The computing system of clauses 1 to 6, wherein a simulated occurrence of a first fault type of the plurality of fault types affects an occurrence probability associated with a second fault type of the plurality of fault types.

Clause 8. The computing system of clauses 1 to 7, wherein the repair resources comprise a resource selected from the group consisting of: time resource, part resource, and labor resource.

Clause 9. The computing system of clauses 1 to 8, wherein the repair resources comprise probabilities of time resources, and wherein the unplanned maintenance time of the simulated fault is calculated using the probabilities of time resources associated with the simulated fault.

Clause 10. The computing system of clauses 1 to 9, wherein the plurality of vehicles comprises a fleet of aircraft.

Clause 11. A method for simulating operational impact of unplanned maintenance for a plurality of vehicles, the method comprising: providing a plurality of operational models with operational data, the plurality of operational models comprising: a route model comprising information describing a route schedule for the plurality of vehicles; a preparation model comprising information describing tasks to prepare a vehicle for departure; a fault model comprising information describing a plurality of fault types, occurrence probabilities associated with the plurality of fault types, and repair resources associated with the plurality of fault types; and an unplanned maintenance delay model for computing delay information; using the plurality of operational models, executing an operational simulation that generates interactions between a route simulation and an unplanned maintenance simulation for a plurality of routes in the route schedule, each route associated with a vehicle of the plurality of vehicles, wherein simulating each route of the plurality of routes comprises: simulating whether a fault occurs using the fault model; if a simulated fault occurs, determining fault type for the simulated fault using the occurrence probabilities of the fault model; calculating unplanned maintenance time using the delay model and the repair resources associated with the simulated fault; and calculating delay using the preparation model and the unplanned maintenance time; and outputting the delays.

Clause 12. The method of clause 11, wherein simulating each route of the plurality of routes further comprises updating the route schedule based on the calculated delay.

Clause 13. The method of clause 11 or clause 12, wherein the delay is calculated based on the unplanned maintenance time and schedule slack information from the preparation model.

Clause 14. The method of clauses 11 to 13, wherein the occurrence probabilities comprise probabilities of a fault type of the plurality of fault types occurring for different phases of a route.

Clause 15. The method of clause 14, wherein the simulation of each route of the plurality of routes further comprises determining a phase in the respective route in which the simulated fault occurs using the occurrence probabilities, and wherein the unplanned maintenance time of the simulated fault is calculated further using the determined phase of the simulated fault.

Clause 16. The method of clauses 11 to 15, wherein a simulated occurrence of a first fault type of the plurality of fault types affects an occurrence probability associated with a second fault type of the plurality of fault types.

Clause 17. The method of clauses 11 to 16, wherein the repair resources comprise a resource selected from the group consisting of: time resource, part resource, and labor resource.

Clause 18. The method of clauses 11 to 17, wherein the repair resources comprise probabilities of time resources, and wherein the unplanned maintenance time of the simulated fault is calculated using the probabilities of time resources associated with the simulated fault.

Clause 19. The method of clauses 11 to 18, wherein the plurality of vehicles comprises a fleet of aircraft.

Clause 20. A computing system for simulating operational impact of unplanned maintenance for a plurality of aircraft, the computing system comprising: one or more processing devices configured to: provide a plurality of operational models with operational data, the plurality of operational models comprising: a route model comprising information describing a route schedule for the plurality of aircraft; a preparation model comprising information describing tasks to prepare an aircraft for departure; a fault model comprising information describing a plurality of fault types, occurrence probabilities associated with the plurality of fault types, and repair resources associated with the plurality of fault types, wherein the occurrence probabilities comprise probabilities of a fault type of the plurality of fault types occurring for different phases of a route; and an unplanned maintenance delay model for computing delay information; using the plurality of operational models, execute an operational simulation that generates interactions between a route simulation and an unplanned maintenance simulation for a plurality of routes in the route schedule, each route associated with an aircraft of the plurality of aircraft, a departure time, and an arrival time, wherein simulating each route of the plurality of routes comprises: simulating whether a fault occurs using the fault model; if a simulated fault occurs, determining fault type for the simulated fault using the occurrence probabilities of the fault model, wherein a simulated occurrence of a first fault type of the plurality of fault types affects an occurrence probability associated with a second fault type of the plurality of fault types; calculating unplanned maintenance time using the delay model and the repair resources associated with the simulated fault; calculating delay using the preparation model and the unplanned maintenance time; and updating the route schedule by updating departure times and arrival times of affected routes due to the calculated delay.

1. A computing system for simulating operational impact of unplanned maintenance for a plurality of vehicles, the computing system comprising:
one or more processing devices configured to:
provide a plurality of operational models with operational data, the plurality of operational models comprising:
a route model comprising information describing a route schedule for the plurality of vehicles;
a preparation model comprising information describing tasks to prepare a vehicle for departure;
a fault model comprising information describing a plurality of fault types; and
an unplanned maintenance delay model for computing delay information;
using the plurality of operational models, execute an operational simulation that generates interactions between a route simulation and an unplanned maintenance simulation for a plurality of routes in the route schedule, each route associated with a vehicle of the plurality of vehicles, wherein simulating each route of the plurality of routes comprises:
simulating whether a fault occurs using the fault model;
if a simulated fault occurs, calculating unplanned maintenance time using the unplanned maintenance delay model and repair resources associated with the simulated fault; and
calculating delay using the preparation model and the unplanned maintenance time; and
output the delays.

2. The computing system of claim 1, wherein simulating each route of the plurality of routes further comprises updating the route schedule based on the calculated delay.

3. The computing system of claim 1, wherein the delay is calculated based on the unplanned maintenance time and schedule slack information from the preparation model.

4. The computing system of claim 3, wherein the schedule slack information is computed based on scheduled preparation time and actual preparation time.

5. The computing system of claim 1, wherein simulating each route of the plurality of routes further comprises determining fault type for the simulated fault using occurrence probabilities associated with the plurality of fault types of the fault model, wherein the occurrence probabilities comprise probabilities of a fault type of the plurality of fault types occurring for different phases of a route.

6. The computing system of claim 5, wherein the simulation of each route of the plurality of routes further comprises determining a phase in the respective route in which the simulated fault occurs using the occurrence probabilities, and wherein the unplanned maintenance time of the simulated fault is calculated further using the determined phase of the simulated fault.

7. The computing system of claim 1, wherein a simulated occurrence of a first fault type of the plurality of fault types affects an occurrence probability associated with a second fault type of the plurality of fault types.

8. The computing system of claim 1, wherein the repair resources comprise a resource selected from the group consisting of: time resource, part resource, and labor resource.

9. The computing system of claim 1, wherein the repair resources comprise probabilities of time resources, and wherein the unplanned maintenance time of the simulated fault is calculated using the probabilities of time resources associated with the simulated fault.

10. The computing system of claim 1, wherein the plurality of vehicles comprises a fleet of aircraft.

11. A method for simulating operational impact of unplanned maintenance for a plurality of vehicles, the method comprising:
providing a plurality of operational models with operational data, the plurality of operational models comprising:
a route model comprising information describing a route schedule for the plurality of vehicles;
a preparation model comprising information describing tasks to prepare a vehicle for departure;
a fault model comprising information describing a plurality of fault types, occurrence probabilities associated with the plurality of fault types, and repair resources associated with the plurality of fault types; and
an unplanned maintenance delay model for computing delay information;
using the plurality of operational models, executing an operational simulation that generates interactions between a route simulation and an unplanned maintenance simulation for a plurality of routes in the route schedule, each route associated with a vehicle of the plurality of vehicles, wherein simulating each route of the plurality of routes comprises:
simulating whether a fault occurs using the fault model;
if a simulated fault occurs, determining fault type for the simulated fault using the occurrence probabilities of the fault model;
calculating unplanned maintenance time using the delay model and the repair resources associated with the simulated fault; and
calculating delay using the preparation model and the unplanned maintenance time; and
outputting the delays.

12. The method of claim 11, wherein simulating each route of the plurality of routes further comprises updating the route schedule based on the calculated delay.

13. The method of claim 11, wherein the delay is calculated based on the unplanned maintenance time and schedule slack information from the preparation model.

14. The method of claim 11, wherein the occurrence probabilities comprise probabilities of a fault type of the plurality of fault types occurring for different phases of a route.

15. The method of claim 14, wherein the simulation of each route of the plurality of routes further comprises determining a phase in the respective route in which the simulated fault occurs using the occurrence probabilities, and wherein the unplanned maintenance time of the simulated fault is calculated further using the determined phase of the simulated fault.

16. The method of claim 11, wherein a simulated occurrence of a first fault type of the plurality of fault types affects an occurrence probability associated with a second fault type of the plurality of fault types.

17. The method of claim 11, wherein the repair resources comprise a resource selected from the group consisting of: time resource, part resource, and labor resource.

18. The method of claim 11, wherein the repair resources comprise probabilities of time resources, and wherein the unplanned maintenance time of the simulated fault is calculated using the probabilities of time resources associated with the simulated fault.

19. The method of claim 11, wherein the plurality of vehicles comprises a fleet of aircraft.

20. A computing system for simulating operational impact of unplanned maintenance for a plurality of aircraft, the computing system comprising:
one or more processing devices configured to:
provide a plurality of operational models with operational data, the plurality of operational models comprising:
a route model comprising information describing a route schedule for the plurality of aircraft;
a preparation model comprising information describing tasks to prepare an aircraft for departure;
a fault model comprising information describing a plurality of fault types, occurrence probabilities associated with the plurality of fault types, and repair resources associated with the plurality of fault types, wherein the occurrence probabilities comprise probabilities of a fault type of the plurality of fault types occurring for different phases of a route; and
an unplanned maintenance delay model for computing delay information;
using the plurality of operational models, execute an operational simulation that generates interactions between a route simulation and an unplanned maintenance simulation for a plurality of routes in the route schedule, each route associated with an aircraft of the plurality of aircraft, a departure time, and an arrival time, wherein simulating each route of the plurality of routes comprises:
simulating whether a fault occurs using the fault model;
if a simulated fault occurs, determining fault type for the simulated fault using the occurrence probabilities of the fault model, wherein a simulated occurrence of a first fault type of the plurality of fault types affects an occurrence probability associated with a second fault type of the plurality of fault types;
calculating unplanned maintenance time using the delay model and the repair resources associated with the simulated fault;
calculating delay using the preparation model and the unplanned maintenance time; and
updating the route schedule by updating departure times and arrival times of affected routes due to the calculated delay.
